(19) United States
(12) Patent Application Publication
(10) Pub. No.: US 2009/0182955 A1
(43) Pub. Date: Jul. 16, 2009

(54) APPLICATION CONFIGURATION ACROSS CLIENT DEVICES OF A LOCAL SYSTEM

(76) Inventor: RAO CHERUKURI, Los Altos Hills, CA (US)

Correspondence Address: Intellevate, P.O. Box 52050, Minneapolis, MN, 55402, US

(21) Appl. No.: 12/412,392

(22) Filed: Mar. 27, 2009

Related U.S. Application Data
(63) Continuation-in-part of application No. 11/517,669, filed on Sep. 8, 2006, now abandoned.
Application No. 11/517,669 is a continuation-in-part of application No. 11/698,478, filed on Jan. 26, 2007.
Application No. 11/698,478 is a continuation-in-part of application No. 12/143,929, filed on Jun. 23, 2008.
(60) Provisional application No. 60/936,875, filed on Jun. 22, 2007.

(51) Int. Cl. G06F 15/16; G06F 12/08

(52) U.S. Cl. 711/141; 709/203; 711/E12.017

(57) ABSTRACT

A method and a system to application configuration across client devices of a local system are disclosed. An exemplary embodiment provides a method for sharing of an application configuration data across client devices. A local storage device of a local system is updated to comprise an application from a remote storage device of a cloud computing system. The application is accessed from the local storage device. The application with a local processing device is implemented without installing the application on the local processing device when requested by the local processing device. Set of function calls are emulated between the application on the local storage device and an operating system of the local processing device.

### PRIORITY CLAIM OR CLAIMS OF PRIORITY

This application is a continuation-in-part of U.S. application Ser. No. 11/517,669 filed on Sep. 8, 2006, application Ser. No. 11/698,478 filed on Jan. 26, 2007, and U.S. application Ser. No. 12/143,929 filed on Jun. 23, 2008. Application Ser. No. 12/143,929 claims the benefit of U.S. Provisional Patent Application No. 60/936,875 filed on Jun. 20, 2007. These applications are incorporated herein by reference.

### FIELD OF TECHNOLOGY

This disclosure relates generally to cloud computing and in one example embodiment to an application configuration in a local area network.

### BACKGROUND

A cloud infrastructure may provide scalable resources over a Wide Area Network (WAN). An enterprise may manage a Local Area Network communicatively associated with the cloud infrastructure via the WAN. The enterprise may install and/or store an application on a remote data base and/or remote server. The enterprise may leverage the storage and/or processing power of the cloud to run the application remotely. The enterprise may utilize a rich client device as a display mechanism to present information of the application running on a remote server. However, the WAN may not possess sufficient bandwidth to adequately maintain a specified level of user experience. Consequently, the enterprise may need to also install the application on a local device of the LAN. Running the application on the local device may require additional system resources (e.g. data storage and processing power). Consuming the additional system resources may degrade the performance of the local system.

### SUMMARY

This Summary is provided to comply with 37 C.F.R. 1.73, requiring a summary of the invention briefly indicating the nature and substance of the invention. It is submitted with the understanding that it will not be used to interpret or limit the scope or meaning of the claims.

Several systems and method to application configuration across client devices of a local system are disclosed.

An exemplary embodiment provides a method for sharing of an application configuration data across client devices. A local storage device of a local system is updated to comprise an application from a remote storage device of a cloud computing system. The application is accessed from the local storage device. The application with a local processing device is implemented without installing the application on the local processing device when requested by the local processing device. A set of function calls are emulated between the application on the local storage device and an operating system of the local processing device.

An exemplary embodiment provides a system for updating a local storage device of a local system. The system includes a cloud interface module to update a local storage device of a local system to comprise an application from a remote storage device of a cloud computing system. The system also includes a file retrieval module to access the application from the local storage device. In addition the system includes an execution module to implement the application with a local processing device without installing the application on the local processing device when requested by the local processing device. Further, a conveyance module of the system emulates a set of function calls between the application on the local storage device and an operating system of the local processing device.

An exemplary embodiment provides a system of cloud data storage. The system includes a cloud data storage of a wide area network to store a data of an application. The system also includes a local peer-to-peer network comprising a node and a peer node. The node and the peer node are communicatively coupled through the local peer-to-peer network. In addition, the system includes a node of the local peer-to-peer network to access the application from the cloud data storage and to store the application on a data memory of the node. Further, a peer node of the local peer-to-peer network accesses the application from the memory of the node and executes the application without installing the application on the peer node. An operating system of the peer node is not modified to perform the function calls between the application and the operating system. The peer node accesses the data memory of the node with the local peer-to-peer network.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying Drawings and from the Detailed Description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 illustrates the communication between the cloud computing storage devices and a local system, according to one embodiment.

FIG. 2 is an exploded view of application execution module illustrated in FIG. 1, according to one embodiment.

FIG. 3 is a systematic view illustrating communication between a local storage device and a local processing device through a LAN, according to one embodiment.

FIG. 4 is a tabular view illustrating details of applications that are accessed by a local system and other details of the network, according to one embodiment.

FIG. 5 is a diagrammatic system view of a data processing system in which any of the embodiments disclosed herein may be performed, according to one embodiment.

FIG. 6A is a process flow that illustrates updating a local storage device of a local system, according to another embodiment.

FIG. 6B is a process flow illustrated in FIG. 6A showing additional embodiments, according to yet another embodiment.

Other features of the present embodiments will be apparent from the accompanying Drawings and from the Detailed Description that follows.

### DETAILED DESCRIPTION

Several methods and a system to application configuration across client devices of a local system are disclosed.

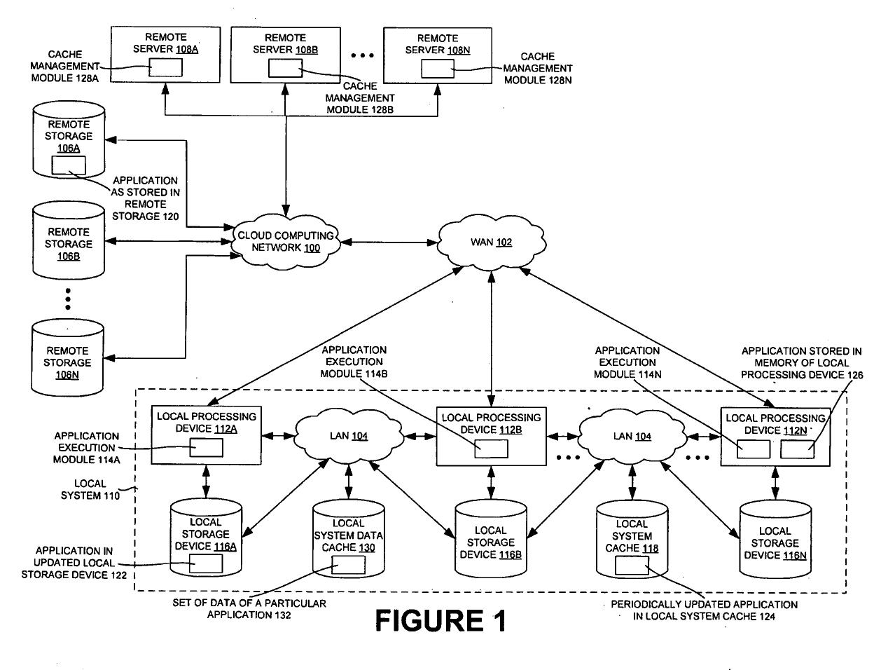

FIG. 1 illustrates the communication between the cloud computing storage devices and a local system, according to one embodiment. Particularly, FIG. 1 illustrates a cloud computing network 100, a WAN 102, a LAN 104, a remote storage 106A-N, a remote server 108A-N, a local system 110. The local system 110 may include a local processing device 112A-N, an Application execution module 114A-N, a local storage device 116A-N, a local system cache 118, an application as stored in remote storage 120, an application in updated local storage device 122, a periodically updated application in local system cache 124, an application stored in a memory of local processing device 126, a cache management module 128A-N and a local system data cache 130, according to one embodiment.

In an example embodiment, the cloud computing network may include cloud components communicating each other. For example, the remote storage 106A-N, and the remote server 108A-N may be communicatively coupled to the local system 110 through the WAN 102. The local system 110 may include the local processing device 112A-N may communicate to each other through the LAN 104. The Local storage device 116A-N and the local processing device may be communicatively coupled to each other through the LAN 104. The local processing device 112A may include an Application execution module 114A. The application in an updated local storage device 122 may be included in the local storage device 116A-N when an application is updated from a remote storage device. The periodically updated application in local system cache 124 may be included in the local system cache 118.

The cloud computing network 100 may be communicatively coupled with the WAN 102, the remote storage 106A-N and the remote server 108A-N. The cloud computing network 100 may be communicatively coupled with the local system 110 via the WAN 102. Network switches and/or routers enable communication between the different parts of the WAN 102. The WAN 102 may use leased lines. The WAN 102 can use circuit switching and/or packet switching methods. For example, network protocols including TCP/IP and/or a Remote Desktop Protocol (RDP) may deliver transport and addressing functions. In other example embodiments, other protocols including Packet over SONET/SDH, MPLS, ATM and Frame relay may be used by a particular service provider of the WAN to deliver a link. The WAN 102 may include leased lines. The WAN 102 may include the Internet.

The components of the local system 110 may be communicatively coupled independent of the WAN 102 via a LAN 104. For example, the local storage device 116A-N may be communicatively coupled to the local processing device 112A-N via the LAN 104. Network switches and/or routers enable communication between the different parts of the LAN 104. The LAN 104 may use switched Ethernet as a common data link layer protocol and IP as a network layer protocol. In certain embodiments, the LAN 104 may also include one or more switches linked to each other. A router, wireless router, cable modem and/or DSL modem may link components of the LAN 104.

According to one embodiment, the cloud computing network 100 may include a network cloud. Data that is transmitted across a WAN 102 enters the network from one end point through a standard protocol then enters the network cloud where it shares space with other data transmissions. The cloud computing network 100 may include a collection of remote server 108A-N and/or remote storage 106A-N maintained by a third-party enterprise. The collection of remote server 108A-N may include both primary and backup servers. A backup server can take over the function of primary servers in the event of a primary server failure. The cloud computing network 100 may include a specified number of clusters of remote storage 106A-N and remote server 108A-N. The clusters may be co-located with the network switches and/or routers. The network switches and/or routers may enable communication between the different parts of the cluster and a user of the cluster (e.g. the enterprise operating local system). For example, the cloud computing network 100 may be an Amazon Elastic Compute Cloud™ (Amazon EC2) provided by Amazon Web Services™ The cloud computing network 100 may provide real-time scalable resources that are provided on-demand. An application may be stored on a remote storage 106A-N of the cloud computing network 100. The application may be installed on a remote server 108A-N of the cloud computing network 100.

The cache management module 128A-N may determine a location of an application in the cloud computing network 100. A software functionality of the cache management module 128A-N may also analyze the location of the application as stored in a node of the local system 110. The cache management module 128A-N may algorithmically process the location data in order to determine a preferred source for a particular local processing device 112A-N to acquire a copy of the application. The cache management module 128A-N may determine a location of the data of the application. The cache management module 128A-N may communicate the location of the data of the application to a local processing device 112A-N. The cache management module 112A-N may include a registry or configuration data for an application and/or user. The cache management module 128A-N may algorithmically determine a preferred location for a particular local processing device 112A-N to access the data of the application. The preferred location may be determined by a specified set of parameters including, inter alia, a proximity of the application to a particular local processing device 112A-N, an availability of the WAN 102, etc. A local cache management module 212 may be extant on the local system 110. The local cache management module 212 may perform the same operations as the cache management module 128A-N of the remote server 108A-N. The local cache management module 212 may interact with the cache management module 128A-N of the remote server 108A-N in order to communicate relevant information regarding the location and availability of applications stored in various locations of the system of FIG. 1.

According to one particular embodiment, the local system cache 118 may store an application executed on the local processing device 112A-N. When a particular application is run on a particular local process device, a particular set of data may be produced. This particular set of data of the particular application 132 may be stored on the local system data cache 130. The local system data cache 130 may be communicatively coupled with the LAN 104. The local system data cache 130 may store the data requirements of the applications run on local nodes of the LAN 104. The data of the particular application 132 may be periodically updated. The cache management module 128A-N may a location of the set of data of the particular application 132 in the LAN 104. In other embodiments, the set of data of the particular application may be stored in the local processing device 112A-N and/or remote storage 106A-N. For example, a Microsoft® Word® application may be stored on the local system cache 118. A particular local processing device 112B may access and run the Word® application. The set of data of a particular Word® document of the Word® application run on the particular local processing device 112B may be stored separately in the local system data cache 130. The set of data of a particular Word® document may be located and/or periodically updated by the cache management module 128B of the remote server 108B. The particular local processing device 112B may access the set of data of a particular Word® document via the LAN 104.

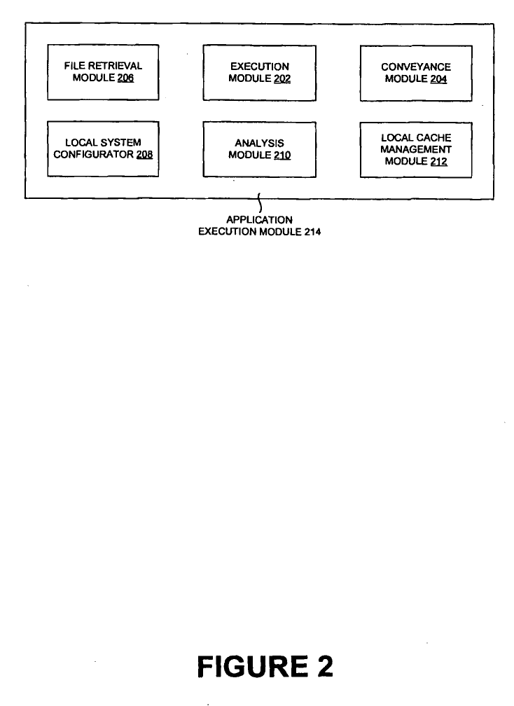

FIG. 2 is an exploded view of application execution module illustrated in FIG. 1. Particularly, FIG. 2 illustrates an execution module 202, a conveyance module 204, a file retrieval module 206, a local system configurator 208, an analysis module 210, a local cache management module 212 and an application execution module 214, according to one embodiment.

In an example embodiment, the application execution module 214 may include the file retrieval module 206, the execution module 202, the conveyance module 204, the local system configurator 208, the analysis module 210, and the local cache management module 212.

In one embodiment, the file retrieval module 206 may access the application that may be stored on the local storage device 116A-N. The file retrieval module 206 may access the application from the cache if the local storage device 116A-N is offline. The file retrieval module may access the application from the remote storage device if a bandwidth of the WAN is greater than the LAN and the application is not available from the local storage devicel 116A-N. The execution Module may execute the application (e.g., that may be stored in the remote storage 106A-N) in the local processing device 112A-N without installing the application in the local storage device. A set of function calls between the application stored on the local storage device 116A-N and an operating system of the local processing device 112A-N may be emulated using the conveyance module 204 module. The conveyance module 204 may provide required resources between the application and the operating system including a registry data, a file system data, and a DLL data. The local system configurator 208 may communicatively couple the local storage device 116A-N and the local processing device 112A-N with a local network capable of transferring data independent of a WAN associated with the local storage device and the cloud computing system. The local system configurator 208 may communicatively couple the local processing device 112A-N with the local system cache 118. The set of applications used in the local system 110 may be analyzed using the analysis module 210. The analysis module 210 may also be used to determine a frequency of use value of each application of the set of applications according to a statistical methodology.

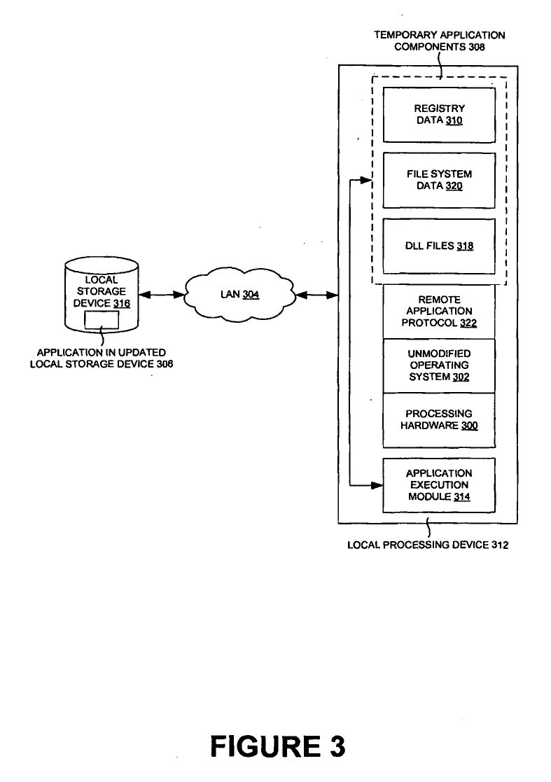

FIG. 3 is a systematic view illustrating communication between a local storage device and a local processing device through a LAN, according to one embodiment. Particularly, FIG. 3 illustrates a processing hardware 300, an unmodified operating system 302, a LAN 304, an application in updated local storage device 306, a temporary application components 308, a registry data 310, a local processing device 312, an application execution module 314, a local storage device 316, a DLL file 318, a file system data 320, and a remote application protocol 322, according to one embodiment.

In an example embodiment, the local storage device 316 may be communicatively coupled to the local processing device 312. The application in local storage device may be transmitted to the local processing device 312 through LAN 304. The local processing device 312 may include the temporary application components 308, the remote application protocol 322, the unmodified operating system 302, the processing hardware, the application execution module 314. The temporary application components 308 may communicate to the application execution module 314.

In one embodiment, the required resources between the application in an updated local storage device and the operating system may include the registry data 310, the file system data and the DLL files. The application execution module 314 may execute the applications that may be accessed from the cloud computing system without installing the applications on the processing system. The processing hardware may process the application that may be required by the local system 110. The remote application protocol 322 may be used to transfer the applications that are stored on the remote storage device. The unmodified operating system 302 may be an operating system that may be accessed from the remote storage 106A-N to execute an application in the local processing device 112A-N. The temporary application components 308 may include the resources between the application and the operating system. The resources may be the registry data 310, the file system data 320, and the DLL file 318. These resources may be provided by the conveyance module 204.

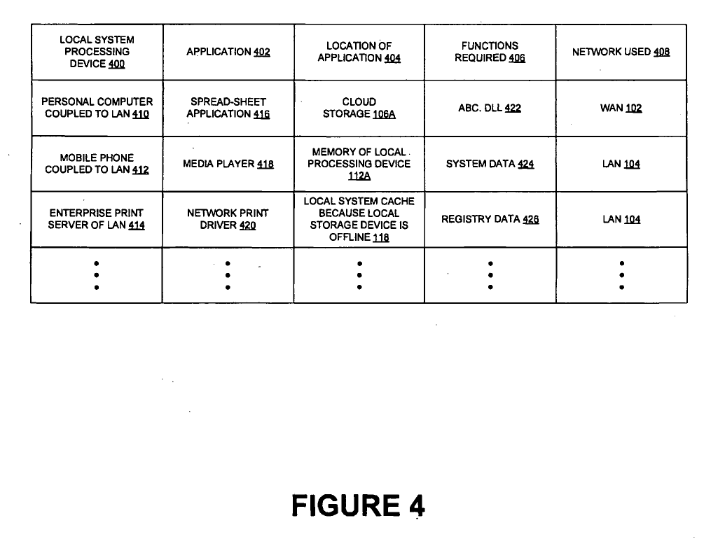

FIG. 4 is a tabular view illustrating details of applications that are accessed by a local system and other details of the network, according to one embodiment. Particularly, FIG. 4 illustrates a local system processing device column 400, an application column 402, a location of application column 404, a functions required column 406, and a network used column 408, according to one embodiment.

According to one embodiment, the column local system processing device 400 may denote the local systems that are accessing various applications from remote storage device of the cloud computing system. For example the local system 110 may be a personal computer that may access an application stored in the remote storage 106A-N. The local system may be a personal computer coupled to LAN 410, a mobile phone coupled to LAN 412, an enterprise print server of LAN 414 and others. The column Application 402 may denote the type of application that may be accessed by the local system. The column location of application 404 may denote the locality of the application that may be accessed by the local system. For example the personal computer coupled to LAN 410 may access a spread-sheet application 416 that is stored in a remote storage 106A. The mobile phone coupled to LAN 412 may access a media player 418 from a memory of local processing device 112A. The enterprise print server of LAN 414 may access a network print driver 420 from the local system cache 118. The column functions required 406 may denote the function required by the accessed application in the column application 402 for its execution. For example the spread-sheet application 416 may use a function ABC.DLL 422, the media player 418 may use a system data 424 and the network print driver 420 may use a registry data 426. The column network used 408 may denote the type of network used to access the application.

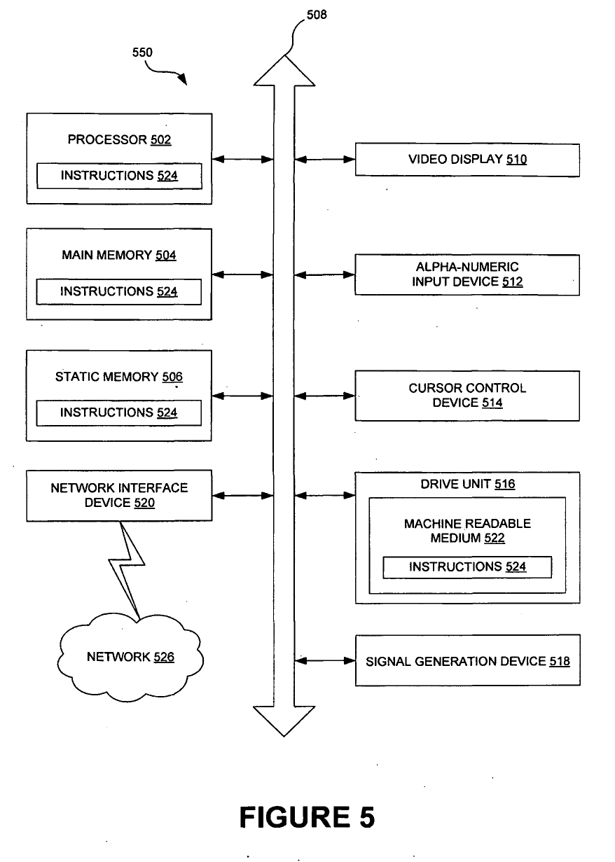

FIG. 5 is a diagrammatic system view of a data processing system in which any of the embodiments disclosed herein may be performed, according to one embodiment. Particularly, the diagrammatic system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or the data processing system in which one or more operations disclosed herein are performed. The processor 502 may be a microprocessor, a state machine, an application specific integrated circuit, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text (e.g., a special device to aid the physically handicapped).

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

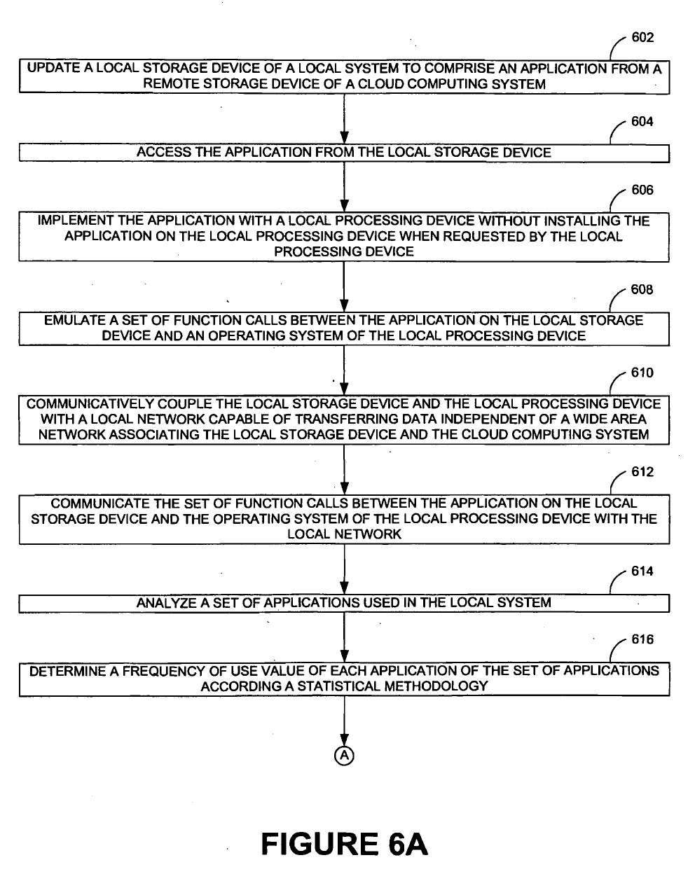

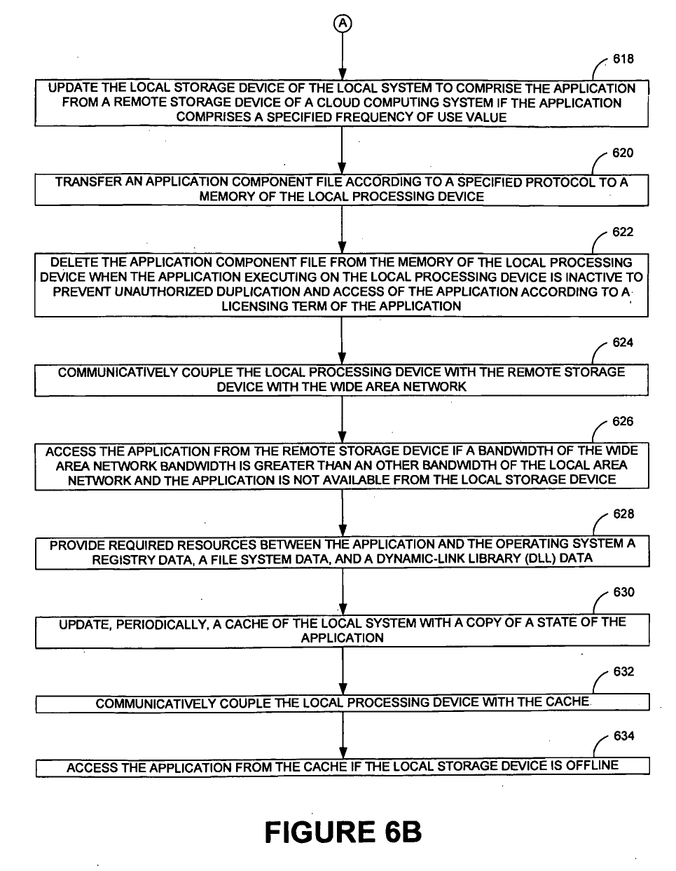

FIG. 6A is a process flow that illustrates updating a local storage device of a local system, according to one embodiment. In operation 602, a local storage device of a local system may be updated to include an application from a remote storage device of a cloud computing system. For example, the local storage device 116A-N of the local system 110 may be updated with an application as stored in cloud computing network 100. In operation 604, the application may be accessed from the local storage device. For example, the application may be accessed from the local storage device 116A-N through the file retrieval module 206 of FIG. 2. In operation 606, the application may be implemented with a local processing device without installing the application on the local processing device when requested by the local processing device. For example, the application may be implemented using the execution module 202. In operation 608, a set of function calls may be emulated between the application on the local storage device and an operating system of the local processing device using the conveyance module 204.

In operation 610, the local storage device 116A-N and the local processing device 112A-N may be communicatively coupled with a local area network 104 of FIG. 1 capable of transferring data independent of a wide area network 102 of FIG. 2 associating the local storage device and the cloud computing system. In operation 612, the set of function calls may be communicated between the application on the local storage device 116A-N and the operating system of the local processing device with the local network. The without installing the application on the local processing device may mean that the operating system of the local processing device is not modified to perform the function calls between the application and the platform. In operation 614, a set of applications used in the local system may be analyzed. For example, the set of applications may be analyzed using the analysis module 210. In operation 616, a frequency of use value of each application of the set of applications may be determined according to a statistical methodology.

FIG. 6B is a process flow illustrated in FIG. 6A showing additional embodiments, according to one embodiment. In operation 618, a location of the data of the application may be determined. In operation 620, a preferred location for accessing the data of the application may be algorithmically determined.

In operation 622, the local storage device 116A-N of the local system 110 may be updated using a cloud interface module to comprise the application from a remote storage device of a cloud computing system if the application comprises a specified frequency of use value. In operation 624, an application component file may be transferred according to a specified protocol to a memory of the local processing device. In operation 626, the application component file may be deleted from the memory of the local processing device 112A-N when the application executing on the local processing device is inactive to prevent unauthorized duplication and access of the application according to a licensing term of the application.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, firmware, software or any combination of hardware, firmware, or software embodied in a machine readable medium. For example, the various electrical structures and methods may be embodied using transistors, logic gates, application specific integrated (ASIC) circuitry or Digital Signal Processor (DSP) circuitry.

Particularly, the cache management module 128A-N of FIG. 1, the execution module 202, the conveyance module 204, the file retrieval module 206, the analysis module 210, the local cache management module 212 and the application execution module 214 of FIG. 2, and the other modules may be enabled using software and/or using transistors, logic gates, and electrical circuits (e.g., application specific integrated ASIC circuitry) such as a cache management circuit, an execution circuit, a conveyance circuit, a file retrieval circuit, an analysis circuit, a local cache management circuit and an application execution circuit and other circuit.

In addition, it will be appreciated that the various operations, processes, and methods disclosed herein may be embodied in a machine-readable medium or a machine accessible medium compatible with a data processing system, and may be performed in any order. Accordingly, the Specification and Drawings are to be regarded in an illustrative rather than a restrictive sense.

What is claimed is:

1. A method comprising:
updating a local storage device of a local system to comprise an application from a remote storage device of a cloud computing system;
accessing the application from the local storage device;
implementing the application with a local processing device without installing the application on the local processing device when requested by the local processing device; and
emulating a set of function calls between the application on the local storage device and an operating system of the local processing device.

2. The method of claim 1 further comprising:
communicatively coupling the local storage device and the local processing device with a local network capable of transferring data independent of a wide area network associating the local storage device and the cloud computing system.

3. The method of claim 2 further comprising:
communicating the set of function calls between the application on the local storage device and the operating system of the local processing device with the local network.

4. The method of claim 3, wherein without installing the application on the local processing device means that the operating system of the local processing device is not modified to perform the function calls between the application and a platform.

5. The method of claim 4: further comprising:
analyzing a set of applications used in the local system.

6. The method of claim 5 further comprising:
determining a frequency of use value of each application of the set of applications according a statistical methodology.

7. The method of claim 6 further comprising:
updating the local storage device of the local system to comprise the application from a remote storage device of a cloud computing system if the application comprises a specified frequency of use value.

8. The method of claim 4 further comprising:
transferring an application component file according to a specified protocol to a memory of the local processing device; and
deleting the application component file from the memory of the local processing device when the application executing on the local processing device is inactive to prevent unauthorized duplication and access of the application according to a licensing term of the application.

9. The method of claim 8 further comprising:
communicatively coupling the local processing device with the remote storage device with the wide area network; and
accessing the application from the remote storage device if at least one of a bandwidth of the wide area network bandwidth is greater than an other bandwidth of the local area network and the application is not available from the local storage device.

10. The method of claim 9, wherein implementing the application with the local processing device comprises:
providing required resources between the application and the operating system comprising a registry data, a file system data, and a Dynamic-Link library (DLL) data.

11. The method of claim 4 further comprising:
updating, periodically, a cache of the local system with a copy of a state of the application, and
communicatively coupling the local processing device with the cache.

12. The method of claim 11 further comprising:
accessing the application from the cache if the local storage device is offline.

13. The method of claim 1, wherein a machine is caused to perform the method of claim 1 when a set of instructions in a form of a machine-readable medium is executed by the machine.

14. A system comprising:
a cloud interface module to update a local storage device of a local system to comprise an application from a remote storage device of a cloud computing system;
a file retrieval module to access the application from the local storage device;
an execution module to implement the application with a local processing device without installing the application on the local processing device when requested by the local processing device; and
a conveyance module to emulate a set of function calls between the application on the local storage device and an operating system of the local processing device.

15. The system of claim 14:
further comprising a local system configurator to communicatively couple the local storage device and the local processing device with a local network capable of transferring data independent of a wide area network associating the local storage device and the cloud computing system, and
wherein without installing the application on the local processing device means that the operating system of the local processing device is not modified to perform the function calls between the application and the platform.

16. The system of claim 14:
further comprising an analysis module to analyze a set of applications used in the local system, and to determine a frequency of use value of each application of the set of applications according a statistical methodology
wherein the cloud interface module updates the local storage device of the local system to comprise the application from the remote storage device of a cloud computing system if the application comprises a specified frequency of use value.

17. The system of claim 14:
further comprising a cache module to update a cache of the local system with a copy of a state of the application,
wherein the local system configurator communicatively couples the local processing device with the cache, and
wherein the file retrieval module accesses the application from the cache if the local storage device is offline.

18. The system of claim 14,
wherein the conveyance module provides required resources between the application and the operating system comprising a registry data, a file system data, and a Dynamic-Link library (DLL) data,
wherein the local system configurator communicatively couples the local processing device with the remote storage device with the wide area network; and
wherein the file retrieval module accesses the application from the remote storage device if at least one of a bandwidth of the wide area network bandwidth is greater than an other bandwidth of the local area network and the application is not available from the local storage device.

19. A system comprising:
a cloud data storage of a wide area network to store a data of an application;
a local peer-to-peer network comprising a node and a peer node and wherein the node and the peer node are communicatively coupled through the local peer-to-peer network;
a node of the local peer-to-peer network to access the application from the cloud data storage and to store the application on a data memory of the node; and
a peer node of the local peer-to-peer network to access the application from the memory of the node and to execute the application without installing the application on the peer node, and wherein an operating system of the peer node is not modified to perform the function calls between the application and the operating system, and wherein the peer node accesses the data memory of the node with the local peer-to-peer network.

20. The system of claim 19 further comprising:
a cache node of the local peer-to-peer network to algorithmically store a copy of the application in a memory of the cache node;
a cache management module of at least one of a remote server and the peer node to determine a location of the data of the application and to algorithmically determine a preferred location for accessing the data of the application;
wherein the peer node accesses the cache to execute the application without installing the application on the peer node, and wherein the operating system of the peer node is not modified to perform the function calls between the application and the operating system, and wherein the peer node accesses the memory of the cache node with the local peer-to-peer network
wherein the node, the peer node and the cache node comprise a data processing device and a data memory.
